(19) United States
(12) Patent Application Publication
(10) Pub. No.: US 2026/0301715 A1
(43) Pub. Date: Oct. 1, 2026

(54) DAMPER MECHANISM FOR UPRIGHT PIANO, AND STAY MEMBER FOR USE IN THE DAMPER MECHANISM

(71) Applicant: KAWAI MUSICAL INSTRUMENTS MANUFACTURING CO., LTD., Hamamatsu-shi (JP)

(72) Inventor: Ryuichi SHINODA, Hamamatsu-shi (JP)

(21) Appl. No.: 19/630,567

(22) Filed: Mar. 27, 2026

(30) Foreign Application Priority Data
Mar. 31, 2025 (JP) 2025-058333

(51) Int. Cl. G10C 3/166; G10C 1/02; G10C 3/161

(52) U.S. Cl. CPC G10C 3/166; G10C 1/02; G10C 3/161

(57) ABSTRACT

A damper mechanism for an upright piano is provided. The mechanism includes: a damper head configured to move away from a string in response to depression of a key and to return to damp vibration of the string in response to release of the key; a damper wire; a damper lever configured to pivot in a direction in which the damper head moves away from the string in response to the depression of the key and to pivot in a direction in which the damper head returns in response to the release of the key; and a stay member extending to be engageable with a sustaining rod that restricts the pivoting of the damper lever in the direction in which the damper head returns after the depression of the key and configured to expose a specific region of the damper wire so as to be accessible from an outside.

### CROSS-REFERENCE TO RELATED APPLICATIONS

This application claims the benefit of Japanese Patent Application No. 2025-058333 filed on Mar. 31, 2025 with the Japan Patent Office, the entire disclosure of which is incorporated herein by reference.

### BACKGROUND

The present disclosure relates to a damper mechanism for an upright piano and a stay member for use in the damper mechanism.

Upright pianos include a damper mechanism for damping vibration of strings. Some of these upright pianos are known to include a sustaining mechanism, for example, as disclosed in Japanese Examined Utility Model Application Publication No. 1-38629 (Patent Document 1).

The sustaining mechanism is configured to sustain a sound for a longer period of time by maintaining a damper of the damper mechanism in a state spaced apart from the strings.

In response to depression of a sustaining pedal after depression of a key, a sustaining rod rotates, and the damper is restricted from returning by a locking protrusion provided on the sustaining rod. This maintains the damper in a state spaced apart from the strings, even after the key is released from a finger. It should be noted that the damper mechanism may be understood to be included in the sustaining mechanism as a part thereof.

A damper mechanism (sustaining mechanism) described in Patent Document 1 includes a damper for damping vibration of strings, a damper wire supporting the damper, and a damper lever holding the damper wire and pivoting in response to a key-depressing operation. The damper lever is provided with an engaging part that is, when the sustaining mechanism exhibits its function, configured to engage with the locking protrusion (referred to as a "claw" in Patent Document 1) of the sustaining rod, thereby restricting the damper lever from pivoting (pivoting in a returning direction).

### SUMMARY

In an upright piano, positions of dampers are appropriately adjusted in order to properly damp vibration of strings. The position of each damper is adjusted by gripping and moving a base portion of a damper wire that supports the damper. Such a work is usually performed in a state in which a damper mechanism (sustaining mechanism) is mounted in the upright piano.

However, due to a mechanism of the upright piano, the damper wire is disposed at a rearward position. Particularly, in the configuration of Patent Document 1, the engaging part provided on the damper lever covers the damper wire, which makes access to the damper wire difficult or impossible. Therefore, it is difficult to access and grip the damper wire with a tool or the like. Consequently, in some cases, even a step of partial disassembly has been required.

Furthermore, in the upright piano that includes a conventional sustaining mechanism, a stay member is disposed at a lower portion of the damper lever, and an adjustment work is performed while adjusting the position of the stay member. However, due to the structure of the upright piano, it has been necessary to remove the keys to adjust the position of the stay member in order to perform the adjustment work.

The present disclosure provides an example of a damper mechanism that enables easier position adjustment of a damper, and a stay member used in the damper mechanism.

One aspect of the present disclosure is a damper mechanism for an upright piano, the damper mechanism comprising a damper head, a damper wire, a damper lever, and particularly a stay member. The damper head is a member configured to move away from a string in response to depression of a key and to return to damp vibration of the string in response to release of the key. The damper wire is a member supporting the damper head. The damper lever is a member holding the damper wire and being configured to pivot in a direction in which the damper head moves away from the string in response to the depression of the key and to pivot in a direction in which the damper head returns in response to the release of the key.

The stay member is coupled to the damper lever, the stay member extending to be engageable with a sustaining rod that restricts the pivoting of the damper lever in the direction in which the damper head returns after the depression of the key and being configured to expose a specific region of the damper wire adjacent to the damper lever so as to be accessible from an outside.

In such a damper mechanism, the stay member provides the following advantages. First, since the stay member is configured to be engageable with the sustaining rod of the sustaining mechanism, the sustaining mechanism can be mounted. Second, the position of the stay member can be adjusted without removing keys in the adjustment work on the sustaining mechanism. Third, since the stay member is configured to expose the specific region of the damper wire adjacent to the damper lever so as to be accessible from the outside, the damper wire can be accessed to be directly gripped and adjusted with a tool or the like. Consequently, the position adjustment of the damper can be performed easily, rather than being difficult as in the conventional technique.

The "specific region of the damper wire adjacent to the damper lever" refers to a region near a holding portion where the damper wire is held by the damper lever, which corresponds to the base portion of the damper wire. According to the present disclosure, since the base portion of the damper wire is easily accessible, the position adjustment of the damper by moving the base portion of the damper wire can be easily performed.

The stay member of the present disclosure may be substantially S-shaped in a side view and may comprise: a first portion extending in a substantially vertical upward direction from an upper portion of the damper lever; a second portion extending in a substantially horizontal direction from the first portion toward a front of the upright piano; and a third portion extending in the substantially vertical upward direction from the second portion.

According to such a configuration, the continuity of the first portion, the second portion, and the third portion allows the stay member to extend while detouring around the damper wire. With this configuration, it is possible to realize a structure "configured to expose the specific region of the damper wire adjacent to the damper lever so as to be accessible from the outside."

The stay member of the present disclosure may have a hole in the second portion through which the damper wire passes. According to this, the stay member can be configured so as not to hinder the function of the damper wire, which extends substantially straight to support the damper. Furthermore, by positioning the damper wire on the inner side of an L-shaped structure formed by the first portion and the second portion, it is possible to realize a structure "configured to expose the specific region of the damper wire adjacent to the damper lever so as to be accessible from the outside" while detouring around the damper wire.

In the present disclosure, the upright piano may include a sustaining mechanism configured to rotate the sustaining rod about a central axis of the sustaining rod in response to depression of a sustaining pedal after the depression of the key, thereby restricting the pivoting of the damper lever in the direction in which the damper head returns by a locking protrusion provided on the sustaining rod to avoid the damping of the vibration of the string. The stay member may have an engaging part at a distal end of the third portion, the engaging part being caught by the locking protrusion when the sustaining pedal is depressed after the depression of the key.

According to this, the effect can be obtained that the position adjustment of the damper in the damper mechanism can be easily performed while realizing the mounting of the sustaining mechanism as described above.

According to another aspect of the present disclosure, a stay member for use in the damper mechanism of an upright piano is disclosed. The features of the stay member are as described above. The aforementioned effects can be achieved even by such a stay member alone. Accordingly, the stay member itself is also included in the technical scope of the present disclosure.

### BRIEF DESCRIPTION OF THE DRAWINGS

An embodiment of the present disclosure will be described hereinafter with reference to the accompanying drawings, in which:

FIG. 1 is a perspective view showing the appearance of an upright piano;

FIG. 2 is a perspective view showing the rear side of the upright piano;

FIG. 3 a view showing a damper mechanism and a sustaining mechanism of the upright piano;

FIG. 4 a view showing the damper mechanism and the sustaining mechanism of the upright piano;

FIG. 5 is an explanatory view showing the damper mechanism;

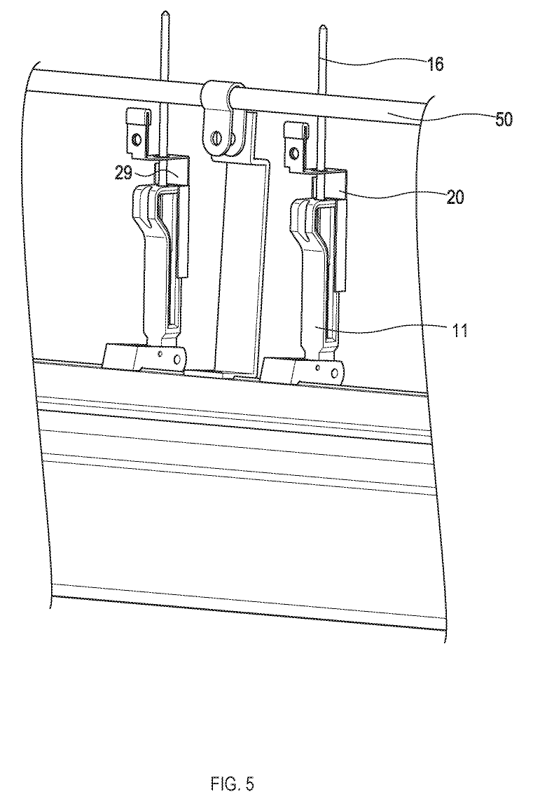

FIG. 6 is an explanatory view showing the damper mechanism;

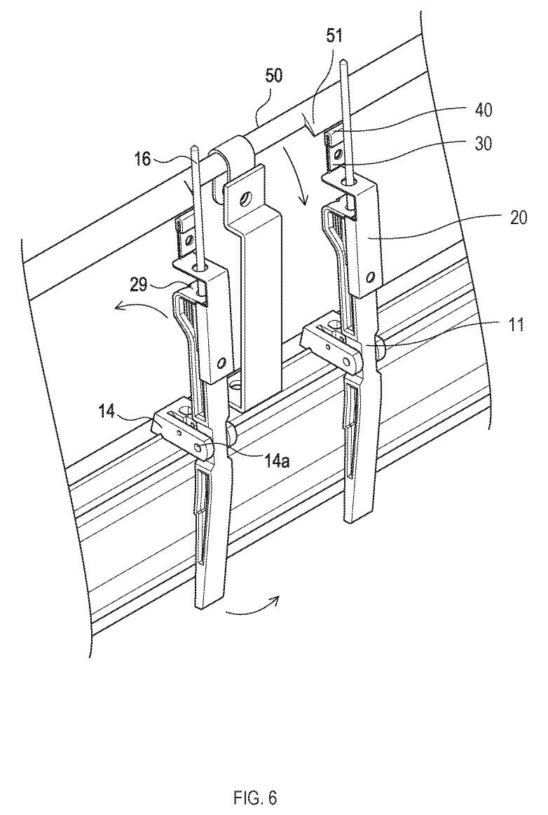

FIG. 7 is a view showing a damper lever and a stay member;

FIG. 8 is a view showing the damper lever and the stay member;

FIG. 9 is a view showing the stay member;

FIG. 10 is a view showing the stay member;

FIG. 11 is a view showing the stay member provided with a tangent; and

FIG. 12 is a view showing the stay member provided with the tangent including a felt.

### DETAILED DESCRIPTION OF EXEMPLARY EMBODIMENTS

### 1. Embodiment

### 1-1. Overall Configuration

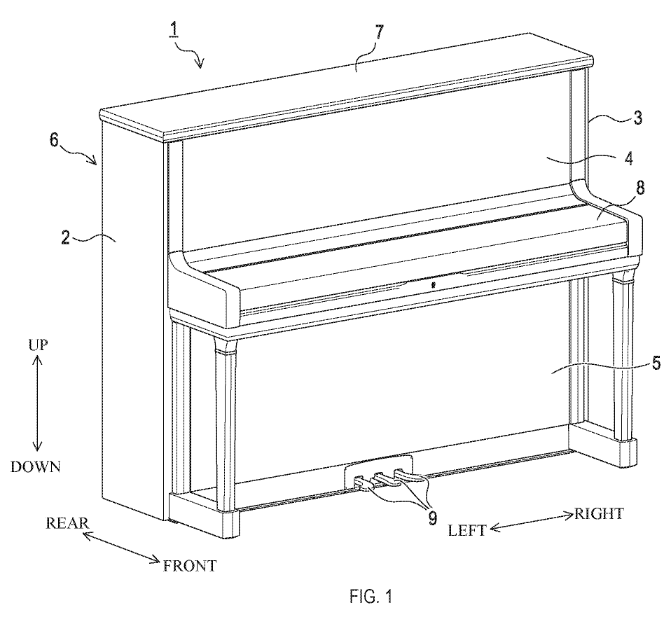

As shown in FIG. 1, an upright piano 1 (hereinafter, simply referred to as “piano 1”) of the present embodiment includes a left side panel 2, a right side panel 3, an upper front panel 4, a lower front panel 5, a rear panel 6, a top panel 7, a fallboard 8, and pedals 9.

In the following description, when the piano 1 is viewed from a player (see FIG. 1), a side that is closer to the player is referred to as “front”, a side that is farther from the player is referred to as “rear”, an upper side is referred to as “up”, a lower side is referred to as “down”, a left side is referred to as “left”, and a right side is referred to as “right”.

The left side panel 2 is a panel member disposed at a left portion of the piano 1. The right side panel 3 is a panel member that is disposed at a right portion of the piano 1. The upper front panel 4 is a panel member that is disposed at an upper portion among a front portion of the piano 1. The lower front panel 5 is a panel member that is disposed at a lower portion among the front portion of the piano 1. The rear panel 6 is a plate member disposed at the side farther from the player (in other words, a rear side) of the piano 1.

The upper front panel 4 and the lower front panel 5 are provided so as to be detachable (openable).

The top panel 7 is a panel member that is disposed above the left side panel 2, the right side panel 3, the upper front panel 4, and the rear panel 6. The top panel 7 is provided so as to be openable and closable via a hinge (not shown).

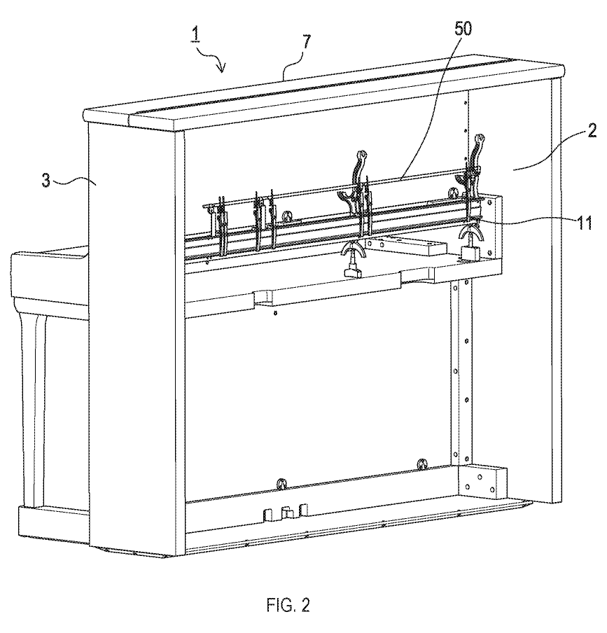

FIG. 2 is a perspective view of the piano 1 as viewed from behind (the rear side) of the piano 1, particularly, in which the rear panel 6 is in a transparent state.

FIG. 2 shows damper levers 11. Although the damper levers 11 are shown at only specific positions, the piano 1 includes a number of damper levers 11 usually used in an upright piano, and the number of the damper levers 11 is not particularly limited. Each of the damper levers 11 has a similar configuration and function.

A sustaining rod 50 is shown in FIG. 2. The sustaining rod 50 will be described below.

### 1-2. Damper Mechanism

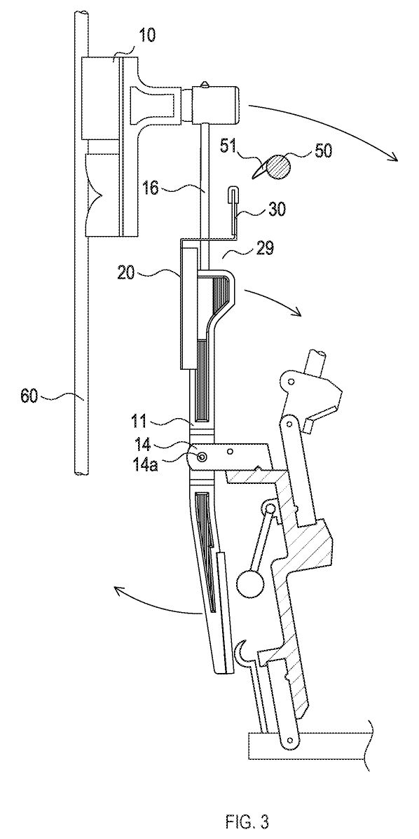

The damper mechanism will be described with reference to FIG. 3.

The damper mechanism includes a damper head 10, the damper lever 11, a damper flange 14, a damper wire 16, and a stay member 20.

In a normal performance, when a user depresses a key, the damper lever 11 rotates about a support shaft 14a of the damper flange 14. As the damper lever 11 rotates, a damper head 10, which is coupled to the damper lever 11 via the damper wire 16, rotates as well. At this time, the damper head 10 rotates so as to move away from the string 60.

When the user releases the depressed key, the damper lever 11 rotates in a direction opposite to a direction in which the damper lever 11 rotates when the key is depressed and returns to its normal state. At this time, the damper head 10 returns to the string 60 and contacts the string 60, thereby damping vibration of the string 60. As a result, a sound is stopped without being sustained.

The piano 1 includes a sustaining mechanism for sustaining a sound for a longer period of time by controlling the damper head 10 to return to the string 60. The sustaining mechanism will be described hereinafter.

### 1-3. Sustaining Mechanism

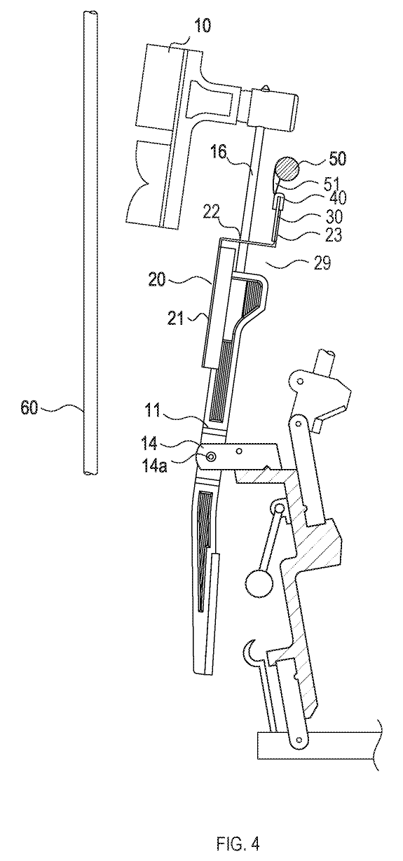

The sustaining mechanism will be further described hereinafter with reference to FIGS. 3 and 4.

The sustaining mechanism includes a sustaining rod 50. A tab lip 51 is formed on the sustaining rod 50. The tab lip 51 corresponds to one example of a locking protrusion.

In a normal performance, when the user releases the key, the damper head 10 returns, and the damper head 10 damps the vibration of the string 60. Accordingly, the sound is stopped without being sustained for a longer period of time.

When the user depresses the key, the damper lever 11 rotates, and the damper head 10 moves away from the string 60. At this time, if the user depresses a sustaining pedal (not shown), the sustaining rod 50 rotates about its central axis (the sustaining rod 50 has not rotated in FIG. 3, but the sustaining rod 50 in FIG. 4 has rotated), and the stay member 20 of the damper mechanism is caught by the tab lip 51 of the sustaining rod 50. More specifically, a tangent 30 provided at a distal end of the stay member 20 is caught by the tab lip 51. The tangent 30 corresponds to one example of the engaging part.

As a result, even after the user releases the key, the tangent 30 remains engaged with the tab lip 51 as long as the sustaining pedal is depressed. Accordingly, the damper lever 11 is restricted from rotating (the damper lever 11 is restricted from returning), and thus the damper head 10 is restricted from returning as well and maintained in a state spaced apart from the string 60. This inhibits damping of the vibration of the string 60, thereby allowing the sound to be sustained for a longer period of time.

### 1-4. Damper Lever

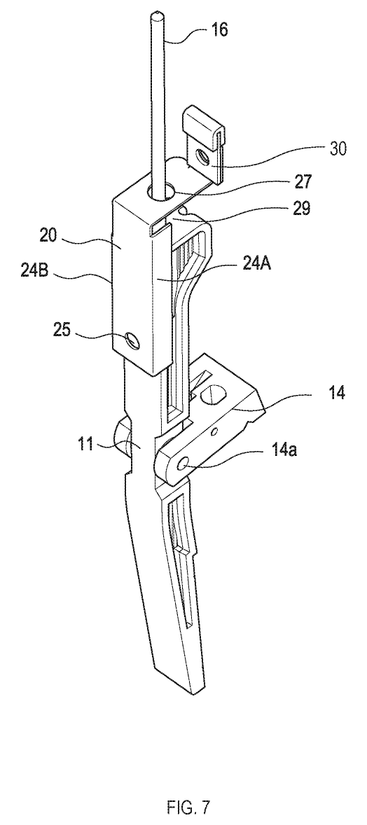

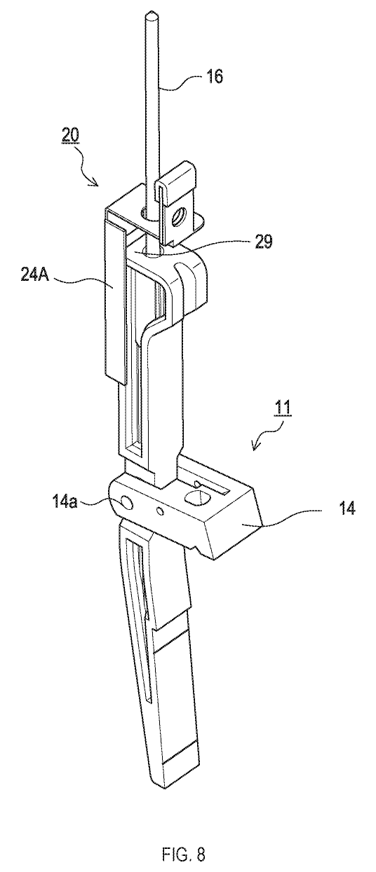

The damper lever 11 will be further described below with reference to FIGS. 7 and 8.

The damper lever 11 is supported by the damper flange 14 so as to be rotatable about the support shaft 14a.

The stay member 20 is attached to the damper lever 11.

It should be noted that the stay member 20 may be understood as a separate component that is independent of the damper lever 11, or the stay member 20 and the damper lever 11 may be understood as an integral component (in other words, the damper lever 11 may include the stay member 20).

### 1-5. Stay Member

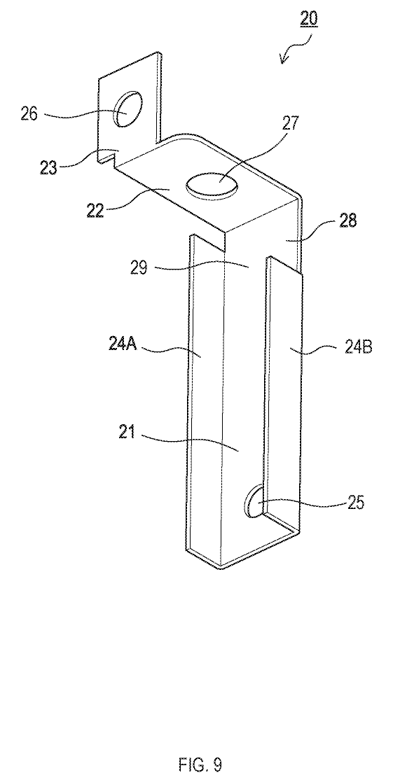

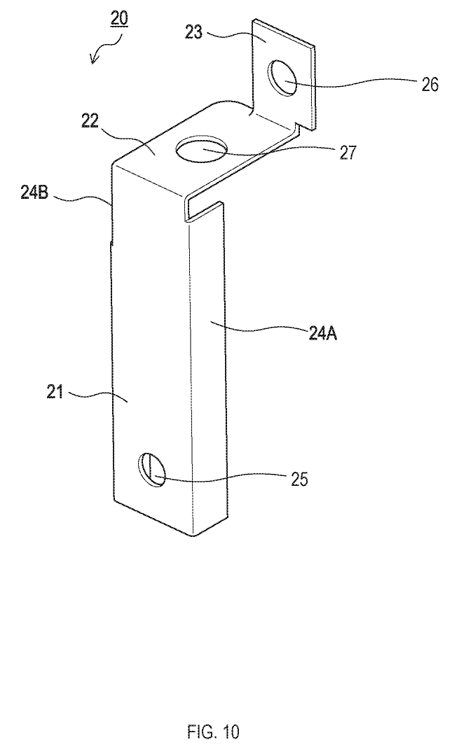

The stay member 20 will be further described below with reference to FIGS. 9 and 10.

The stay member 20 includes a first portion 21, a second portion 22, and a third portion 23. The stay member 20 includes a side wall 24A, a side wall 24B, a screw hole 25 for the damper lever 11, a screw hole 26 for the tangent 30, a hole 27 through which the damper wire 16 passes, and an open portion 29.

The stay member 20 is substantially S-shaped in a side view. In a state in which the stay member 20 is attached to the piano 1 (in a state in which the stay member 20 is attached to the damper lever 11), the first portion 21 extends in a substantially vertical upward direction from the damper lever 11, the second portion 22 extends in a substantially horizontal direction from the first portion 21 toward the front of the piano 1, and the third portion 23 extends in a substantially vertical upward direction from the second portion 22. The hole 27 is formed in the second portion 22.

The stay member 20 is configured to expose a specific region of the damper wire 16 adjacent to the damper lever 11 so as to be accessible from the outside by being substantially S-shaped in a side view as described above. Referring to FIGS. 3 and 4, the open portion 29 is formed, and the specific region of the damper wire 16 adjacent to the damper lever 11 is accessible through the open portion 29. The specific region of the damper wire 16 is a base portion of the damper wire 16.

The first portion 21 of the stay member 20 includes the screw hole 25 for the damper lever 11 such that the stay member 20 is attachable to the damper lever 11. The stay member 20 is fixed to the damper lever 11 via the screw hole 25 for the damper lever 11.

The third portion 23 of the stay member 20 includes the screw hole 26 for the tangent 30 such that the tangent 30 is attachable to the third portion 23. In a state in which the tangent 30 is mounted to the stay member 20, the screw hole 26 for the tangent 30 and a hole 31 of the tangent 30 are continuous with each other. The stay member 20 and the tangent 30 are integrally coupled to each other via a wing screw (not shown).

The stay member 20 includes the side wall 24A and the side wall 24B. The side wall 24A and the side wall 24B have different lengths from each other. Upon attachment, a reference for the attachment is provided by aligning an upper surface of the side wall 24B with an upper surface of the damper lever 11.

After the stay member 20 is attached, a tool can be inserted through an opening 28 located above the side wall 24B to access the damper wire 16 to perform an adjustment operation on the damper wire 16. The side wall 24A has a function of providing the strength of the entire stay member 20. Accordingly, the longer the side wall 24A is, the greater an effect of enhancing the strength of the entire stay member 20 becomes.

When the stay member 20 is viewed from the front, the open portion 29 is formed between the side wall 24A and the side wall 24B, and the damper wire 16 is accessible through the open portion 29. In other words, the open portion 29 is formed by a continuous shape (bent shape) of the first portion 21 and the second portion 22.

The stay member 20 is attached to an upper portion of the damper lever 11, extends in a substantially vertical upward direction from the damper lever 11, bends by substantially 90 degrees to extend toward the front of the piano 1 in a horizontal direction, further bends by substantially 90 degrees to extend in the substantially vertical upward direction.

Conventionally, when adjusting the sustaining mechanism (adjusting the damper head 10), it was necessary to temporarily remove a key at a position to be adjusted and insert a hand (or a tool) through a resulting gap to adjust the position of the stay member provided at a lower portion of the damper lever. Thereafter, it was common practice to perform adjustment work such as reattaching the key and depressing the key to confirm that the sustaining mechanism operates. According to the stay member 20, since the stay member 20 is provided at the upper portion of the damper lever 11, it is possible to access the stay member 20 through the open portion 29 and/or the opening 28 without removing the key. Therefore, the stay member 20 can be adjusted while the key remains attached without being removed, which makes the adjustment work easier and more efficient.

### 1-6. Tangent

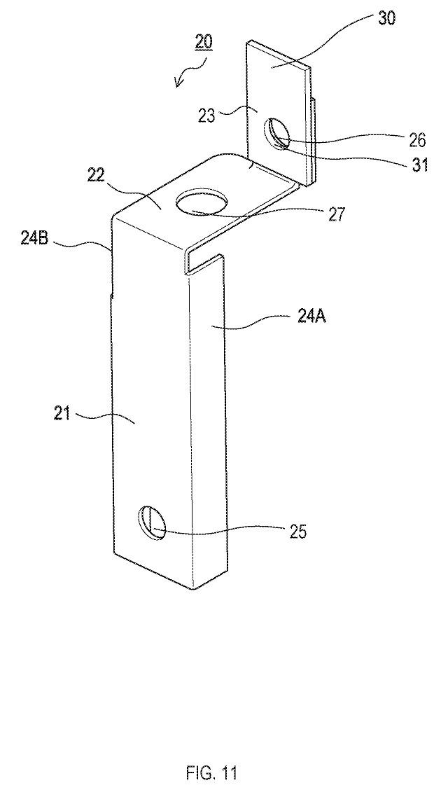

The tangent 30 will be further described below with reference to FIG. 11. The tangent 30 includes the hole 31.

In the piano 1, the tangent 30 is attached to the third portion 23 that corresponds to the distal end of the stay member 20. When the tangent 30 is caught by the tab lip 51 of the sustaining rod 50, the damper lever 11 is held in a state in which the damper lever is rotated in a direction in which the damper head 10 moves away from the string 60. Accordingly, the damper head 10 is maintained in a state of being spaced apart from the string 60.

The tangent 30 is fixed to the stay member 20 via the screw hole 26 for the tangent 30 formed in the third portion 23 of the stay member 20. The tangent 30 is attached to the stay member 20 so as to be adjacent to the stay member 20.

### 1-7. Felt

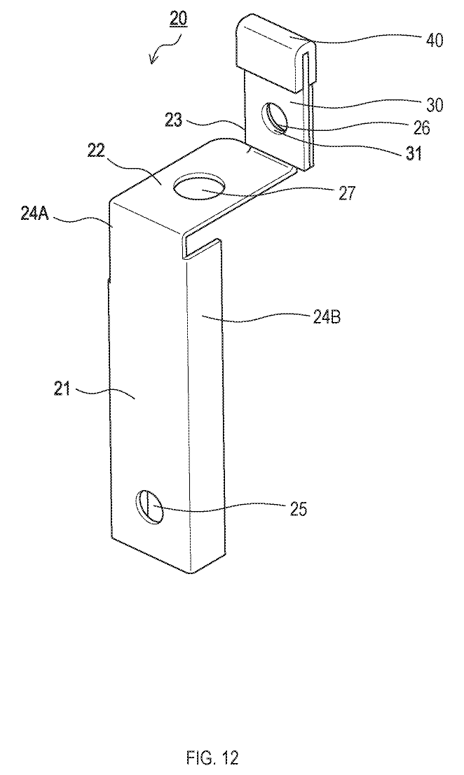

Referring to FIG. 12, the tangent 30 may be provided with a felt 40. By providing the felt 40, an impact caused by the tangent 30 contacting the tab lip 51 of the sustaining rod 50 can be absorbed. Accordingly, wear on the tangent 30 can be reduced. In terms of maintenance operations, it is only necessary to clean or replace the felt 40, which facilitates the maintenance operations.

The felt 40 may be understood as a separate component independent of the tangent 30, or the tangent 30 and the felt 40 may be understood as an integral component (in other words, the tangent 30 may include the felt 40).

### 1-8. Other Effects

Since the stay member 20 is attached to the upper portion of the damper lever 11, the sustaining mechanism can be mounted even in a small upright piano having a limited internal space.

### 1-9. Situations in which Effects are Exerted

By using the stay member 20, the open portion 29 is provided, which allows the damper wire 16 to be adjusted while the key remains attached. This enables the adjustment work to be performed without being inhibited. Therefore, the adjustment work can be performed without the steps of removing the key, performing the adjustment, and finally reattaching the key. Furthermore, compared to an upright piano having a conventional sustaining mechanism, the sustaining mechanism can be adjusted by adjusting the position of the stay member 20 without removing the key. This makes it possible not only to reduce the workload of an operator performing the adjustment work but also to shorten the total time required for the adjustment work.

By using the stay member 20, adjustment operations are facilitated through the opening 28 and/or the open portion 29.

### 1-10. Other Embodiment

Although the stay member 20 is made of metal, the material is not limited to metal. For example, the stay member 20 may be made of resin, wood, or other materials.

The stay member 20 includes the first portion 21, the second portion 22, and the third portion 23 arranged at an angle of substantially 90 degrees relative to one another. However, the angle is not limited to 90 degrees. For example, the angle may be 45 degrees to 270 degrees. The angle may be set such that the stay member 20 can be appropriately disposed inside the piano.

The stay member 20 is attached to the damper lever 11, but the attachment location is not limited thereto. For example, the stay member 20 may be attached to a portion other than the damper lever 11 depending on a shape of the damper lever 11 or a positional relationship with a main body of the piano 1.

What is claimed is:

1. A damper mechanism for an upright piano, the damper mechanism comprising:
a damper head configured to move away from a string in response to depression of a key and to return to damp vibration of the string in response to release of the key;
a damper wire supporting the damper head;
a damper lever holding the damper wire, the damper lever being configured to pivot in a direction in which the damper head moves away from the string in response to the depression of the key and to pivot in a direction in which the damper head returns in response to the release of the key; and
a stay member coupled to the damper lever, the stay member extending to be engageable with a sustaining rod that restricts the pivoting of the damper lever in the direction in which the damper head returns after the depression of the key and being configured to expose a specific region of the damper wire adjacent to the damper lever so as to be accessible from an outside.

2. The damper mechanism according to claim 1,
wherein the stay member is substantially S-shaped in a side view and comprises:
a first portion extending in a substantially vertical upward direction from an upper portion of the damper lever;
a second portion extending in a substantially horizontal direction from the first portion toward a front of the upright piano; and
a third portion extending in the substantially vertical upward direction from the second portion.

3. The damper mechanism according to claim 1,
wherein the stay member includes a hole provided in the second portion, the damper wire passing through the hole.

4. The damper mechanism according to claim 1,
wherein the upright piano comprises a sustaining mechanism configured to rotate the sustaining rod about a central axis of the sustaining rod in response to depression of a sustaining pedal after the depression of the key, thereby restricting the pivoting of the damper lever in the direction in which the damper head returns by a locking protrusion provided on the sustaining rod to avoid the damping of the vibration of the string, and
wherein the stay member has an engaging part at a distal end of the third portion, the engaging part being caught by the locking protrusion when the sustaining pedal is depressed after the depression of the key.

5. A stay member for use in a damper mechanism for an upright piano, the damper mechanism comprising:
a damper head configured to move away from a string in response to depression of a key and to return to damp vibration of the string in response to release of the key;
a damper wire supporting the damper head;
a damper lever holding the damper wire, the damper lever being configured to pivot in a direction in which the damper head moves away from the string in response to the depression of the key and to pivot in a direction in which the damper head returns in response to the release of the key; and
the stay member,
the stay member being coupled to the damper lever, the stay member extending to be engageable with a sustaining rod that restricts the pivoting of the damper lever in the direction in which the damper head returns after the depression of the key and being configured to expose a specific region of the damper wire adjacent to the damper lever so as to be accessible from an outside.
